(19) United States
(12) Patent Application Publication
(10) Pub. No.: US 2005/0283601 A1
(43) Pub. Date: Dec. 22, 2005

(54) Systems and methods for securing a computer boot

(75) Inventor: Thomas E. Tahan, San Diego, CA (US)

Correspondence Address: MARTINE PENILLA & GENCARELLA, LLP, 710 LAKEWAY DRIVE, SUITE 200, SUNNYVALE, CA, 94085, US

(73) Assignee: SUN MICROSYSTEMS, INC., SANTA CLARA, CA (US)

(21) Appl. No.: 10/934,868

(22) Filed: Sep. 3, 2004

Related U.S. Application Data
(60) Provisional application No. 60/582,206, filed on Jun. 22, 2004.

(51) Int. Cl. G06F 9/00

(52) U.S. Cl. 713/2

(57) ABSTRACT

A method for securing a computer boot is provided. In this method, integrity measurements of program code being loaded for execution are taken during the computer boot, and the integrity measurements are stored in a system board trusted platform module (SBTPM). Subsequently, the integrity measurements are transferred from the SBTPM to a trusted platform module peripheral (TPMP) when the TPMP is initialized and accessible. Systems for securing a computer boot are also described.

### CROSS REFERENCE TO RELATED APPLICATIONS

This application claims the benefit of U.S. Provisional Application No. 60/582,206, filed Jun. 22, 2004. The disclosure of the provisional application is incorporated herein by reference.

### BACKGROUND OF THE INVENTION

1. Field of the Invention

The present invention relates generally to data security and, more particularly, to methods and systems for securing a computer boot.

2. Description of the Related Art

As a desktop computer boots, the desktop computer may load unauthorized software and firmware components. In other words, software and firmware in a boot chain may be hacked. To ensure that the correct software and firmware components are loaded during the boot, integrity measurements (e.g., cryptographic checksums of computer code using an algorithm such as SHA-1) are taken on each of the software and firmware components in the boot chain.

As the integrity measurements are taken, the integrity measurements are stored in a trusted platform module (TPM). The TPM is a security component specified by a Trusted Computing Group, often implemented as a single chip. The TPM provides secure boot capability for a desktop computer, as well as a protected storage capability for storing sensitive information such as cryptographic keys and integrity measurements.

A shortcoming of currently-available TPMs is that these TPMs have limited memory to store the integrity measurements and limited performance capabilities. For a simplistic desktop computer, the limited memory in the TPM is sufficient to store the integrity measurements as relatively few software and firmware components are loaded during the computer boot. However, a complex server system has many more software and firmware components to load during the computer boot when compared to the desktop computer and, as such, the currently-available TPMs do not have sufficient memory to store the integrity measurements of a server system. Further, a server has far greater performance requirements than a typical desktop computer necessitating higher performance, scalable TPM solutions.

In view of the foregoing, there is a need to provide systems and methods for securing a computer boot suited to the requirements of a server system.

### SUMMARY OF THE INVENTION

Broadly speaking, the present invention fills these needs by providing systems and methods for securing a computer boot and providing a secure communication. It should be appreciated that the present invention can be implemented in numerous ways, including as a process, an apparatus, a system, computer readable media, or a device. Several inventive embodiments of the present invention are described below.

In accordance with a first aspect of the present invention, a method for securing a computer boot is provided. In this method, integrity measurements of program code being loaded for execution are taken during the computer boot, and the integrity measurements are stored in a system board trusted platform module (SBTPM). Subsequently, the integrity measurements are transferred from the SBTPM to a trusted platform module peripheral (TPMP) when the TPMP is initialized and accessible.

In accordance with a second aspect of the present invention, a system for securing a computer boot is provided. The system includes a central processing unit (CPU) that includes logic for executing instructions for taking integrity measurements of program code being loaded for execution during the computer boot, and instructions for storing the integrity measurements in a SBTPM until a TPMP is initialized and accessible. The system additionally includes the SBTPM in communication with the CPU configured to store the integrity measurements. The SBTPM includes logic for executing instructions for transferring the integrity measurements to the TPMP after the TPMP is initialized and accessible. The system also includes the TPMP in communication with the CPU configured to receive and store the integrity measurements.

In accordance with a third aspect of the present invention, a system for securing a computer boot is included. The system includes a logic component that includes logic for executing instructions for taking integrity measurements of program code being loaded for execution during the computer boot, and instructions for storing the integrity measurements in a SBTPM until a TPMP is initialized and accessible. The system also includes a SBTPM in communication with the logic component configured to store the integrity measurements and a TPMP in communication with the SBTPM. Here, the TPMP includes logic for receiving the integrity measurements from the SBTPM after the TPMP is initialized and accessible.

In accordance with a fourth aspect of the present invention, a chip for securing a computer boot is provided. The chip includes circuitry for storing integrity measurements and circuitry for transferring the integrity measurements to a TPMP when the TPMP is initialized and accessible.

In accordance with a fifth aspect of the present invention, a TPMP for securing a computer boot is provided. The TPMP includes logic for receiving registration information for an attestation identification key pair (AIK) over a secure administrative path; logic for receiving an AIK public key; logic for validating the AIK public key; logic for communicating an attestation challenge to a SBTPM when the TPMP is initialized and accessible; and logic for receiving an attestation reply from the SBTPM.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a flowchart diagram of a high level overview of a method for securing a computer boot, in accordance with one embodiment of the present invention.

FIG. 2 is a simplified block diagram of a more detailed overview for securing a computer boot, in accordance with one embodiment of the present invention.

FIG. 3 is a simplified schematic diagram of a system for securing a computer boot, in accordance with one embodiment of the present invention.

FIG. 4 is a flowchart diagram of a high level overview of a method for providing a basic secured path, in accordance with one embodiment of the present invention.

FIG. 5 is a simplified block diagram of a more detailed overview for providing a basic secured path, in accordance with one embodiment of the present invention.

FIG. 6 is a flowchart diagram of a high level overview of a method for providing a high performance secured path, in accordance with one embodiment of the present invention.

FIG. 7 is a simplified block diagram of a more detailed overview for providing a high performance secured path, in accordance with one embodiment of the present invention.

### DETAILED DESCRIPTION

An invention is disclosed for systems and methods for securing a computer boot and performing secure communications among system components. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

### I. Secure Boot with a Trusted Platform Module Peripheral

The embodiments described herein provide systems and methods for securing a computer boot. Essentially, integrity measurements are stored both on a system board trusted platform module (SBTPM) and on a trusted platform module peripheral (TPMP). As will be explained in more detail below, in one embodiment, the integrity measurements are initially stored on the SBTPM. After the TPMP is initialized and accessible, the integrity measurements are transferred from the SBTPM to the TPMP.

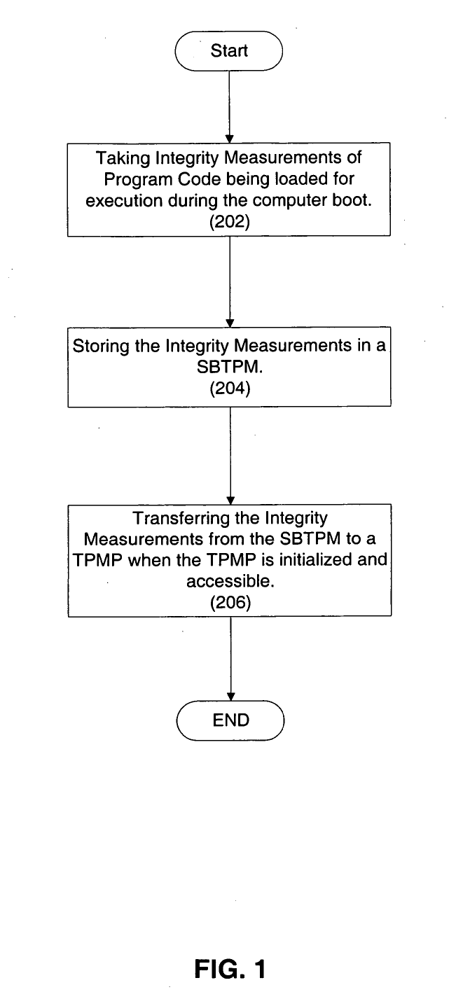

FIG. 1 is a flowchart diagram of a high level overview of a method for securing a computer boot, in accordance with one embodiment of the present invention. Starting in operation 202, integrity measurements of program code being loaded for execution are taken during the computer boot. A computer boot is an initial program load, and integrity measurements are cryptographic checksums of the program code being loaded for execution during the computer boot. Exemplary integrity measurement algorithms include Secure algorithms, asymmetric cryptographic algorithms, etc.

Thereafter, in operation 204, the integrity measurements are stored in a SBTPM. One skilled in the art will appreciate that a trusted platform module (TPM) may be a security component specified by the Trusted Computing Group and the TPM may be used to secure a computer boot. The TPM may be a secure micro-controller with cryptographic functionalities. For example, the TPM can provide a secure boot capability for a platform, as well as a protected storage capability for storing sensitive information such as cryptographic keys and integrity measurements. In one embodiment, the TPM may be implemented in a chip or a chip set that is physically attached to a system board (e.g., a motherboard) or to another part of the platform accessible by a central processing unit (CPU). The TPM is to be physically attached to the part of the platform that is used to identify the platform. For this purpose, a TPM that is physically attached to the platform is defined as the SBTPM.

Subsequently, in operation 206, the integrity measurements stored in the SBTPM are transferred to a TPMP when the TPMP is initialized and accessible. TPMP is initialized when the TPMP has been configured and is in an operational state, and the TPMP is accessible when the path between the CPU and the TPMP is configured and is in an operational state. As discussed above, in one embodiment, the TPM may be soldered onto the system board with optional additional strong adhesive. In another embodiment, the TPM may physically reside in one or multiple cards. It should be appreciated that the card is circuitry designed to provide expanded capability to a computer. The circuitry is provided on the surface of a standard-size rigid material and then plugged into the computer's expansion slots. Exemplary cards include Peripheral Component Interconnect (PCI) cards, PCI-X cards, PCI-Express cards, infiniband terminal communications adapters, etc. In addition, the TPMP may be on one or multiple cards physically housed within a network appliance or other machine. Having the TPM on one or more cards may be used, for example, in a server where the incorporation of a high performance and high assurance TPM on a system board would be impractical or infeasible. Furthermore, the card can accommodate a larger, more sophisticated TPM that includes more memory to store integrity measurements. For example, as will explained in more detail below, before the memory of the SBTPM for storing integrity measurements is depleted, the integrity measurements may be transferred to a TPMP with a larger capacity memory. For this purpose, a TPM that physically resides in one or more cards connected through a peripherals interface to the system is referred to as the TPMP.

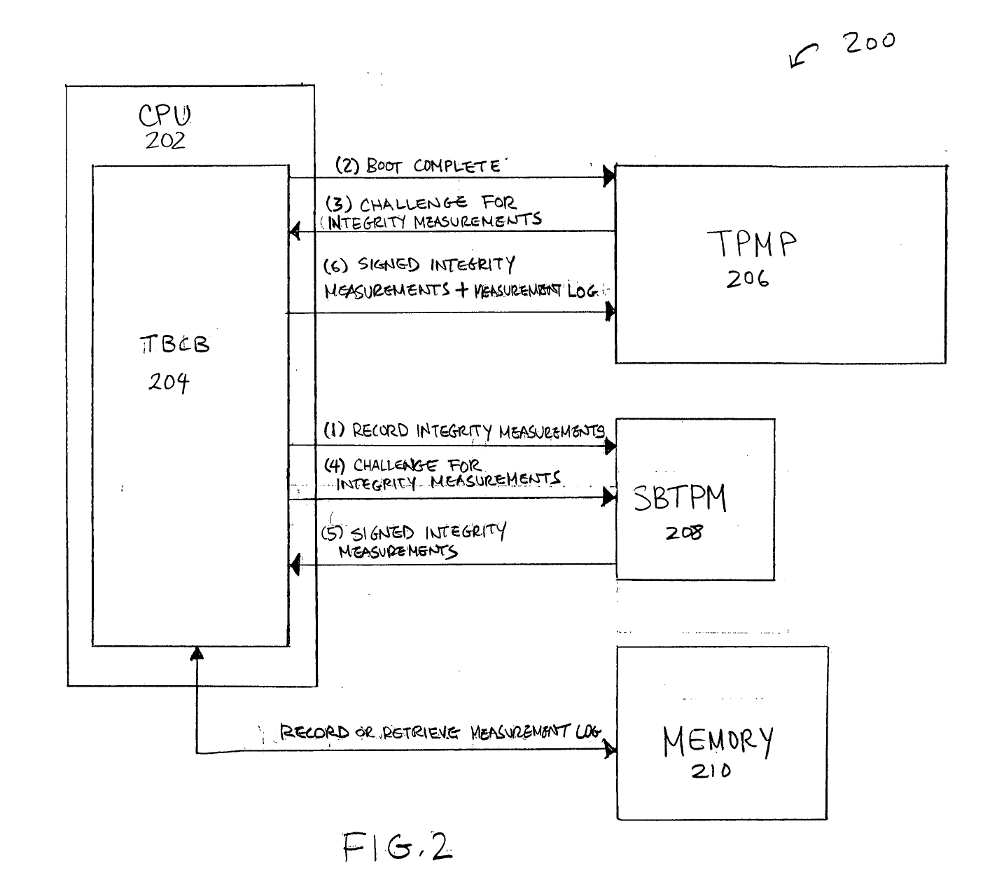

FIG. 2 is a simplified block diagram of a more detailed overview for securing a computer boot, in accordance with one embodiment of the present invention. Computer system 200 includes CPU 202, TPMP 206, SBTPM 208, and memory 210. CPU 202 may include any suitable processor. Exemplary processors include Scalable Processor Architecture (SPARC) processors, Pentium processors, PowerPC processors, Opteron processors, Xeon processors, Itanium processors, etc. Examples of memory 210 include any suitable memory types, such as static access memory (SRAM), dynamic random access memory (DRAM), etc. As shown in FIG. 2, CPU 202 is in communication with TPMP 206, SBTPM 208, and memory 210. One skilled in the art will appreciate that while CPU 202, TPMP 206, SBTPM 208, and memory 210 are illustrated as being interconnected, each of these components may be in communication through a common bus. The TPMP could also be within an appliance or other machine connected by a network such as Ethernet to CPU 202.

As discussed above, integrity measurements taken during a computer boot may be transferred to TPMP 206. However, during the early phases of the computer boot, the chip set and the buses on which TPMP 206 resides may not have been initialized or may not be operational. Thus, before the TPMP is initialized and accessible, the integrity measurements cannot be transferred to or received by TPMP 206. Furthermore, signaling locality over a general purpose bus is not possible if the platform does not have special mechanism to allow such signaling. On the other hand, SPTPM 208 is on a local, low complexity bus (e.g., low pin count (LPC) bus) on the platform and the SPTPM may easily accommodate the recordation of the initial boot integrity measurements and the signaling of locality (per Trusted Computing Group specification). Thus, the integrity measurements may be initially stored in SBTPM 208 before TPMP 206 is initialized. After TPMP 206 is initialized and accessible, the integrity measurements stored on SBTPM 208 are then transferred to the TPMP.

As shown in FIG. 2, integrity measurements are first recorded and stored in SBTPM 208. The integrity measurements and recording process begin with CPU 202, SBTPM 208, and other components on the platform being reset either under external control or under the control of a component on the platform. After the reset, in one embodiment, CPU 202 starts executing program code in an immutable boot block. CPU 202 then performs an integrity measurement on a next program code to execute in a boot chain of trust and associated configuration data of the program code (if any). Thereafter, CPU 202 records the integrity measurement in SBTPM 208. It should be appreciated that each component in the boot chain of trust measures the next program code to execute and stores the associated integrity measurements in SBTPM 208.

The integrity measurement calculations and storing the integrity measurements in SBTPM 208 proceeds up to and including the integrity measurement of the program code that is able to access TPMP 206. This stage of the computer boot is referred to as the TPMP capable stage, and the code base that is executing in CPU 202 at this stage is referred to as Trusted Boot Code Base (TBCB 204). In one embodiment, a measurement log is also maintained. The measurement log includes descriptions of the integrity measurements, including what code was measured in what order, and the location (platform configuration register) where each measurement is stored within SBTPM 208. The measurement may be stored in memory 210 or any suitable storage medium accessible by TBCB 204.

Whenever the platform reaches the TPMP capable stage, TBCB 204 notifies TPMP 206 and the TPMP communicates an attestation challenge to SBTPM 208. In one embodiment, TBCB 204 forwards the attestation challenge from TPMP 206 to SBTPM 208. In another embodiment, the attestation challenge may be communicated by TPMP 206 to SBTPM 208 through a connection not requiring CPU 202. In response, SBTPM 208 communicates an attestation reply to TPMP 206. The attestation reply includes the stored integrity measurements and is digitally signed (i.e., encrypted) using a private key component of an attestation identification key pair (AIK). SBTPM 208 may either use the private key component of the AIK to encrypt the entire reply data, or may compute a one-way hash of the attestation reply data and then encrypt the result of the hash using the private key component of the AIK. An Endorsement Key pair (EK) may also be used instead of the AIK. On older versions (pre-version 1.2) of the TPM, the EK is the only option available.

In one embodiment, registration of the public key component of the AIK is through a public key method. As is known to those skilled in the art, digital signature using asymmetric (i.e., public key) encryption is a cryptographic system that uses a public key known to everyone and a private known only to the sender of the message. The public and private keys are related in such a way that the public key can be used to encrypt messages and the corresponding private key can be used to decrypt the messages, or vice versa. For performance reasons, asymmetric encryption is often used in conjunction with a one-way hash function, where the one-way hash is computed over the data to be signed and the asymmetric algorithm is used to encrypt the result of the one-way hash computation. To validate and decrypt the attestation reply, the public key component of the AIK is registered with TPMP 206. In one embodiment, registration of the public key with TPMP 206 uses the public key method. Here, the public key component of the AIK is entered into TPMP 206 through a secure administrative path when the TPMP is first installed and when the TPMP is configured. When the public key method is used, the TPMP's validation of the public key prior to using the public key consists retrieving the public key from the memory of TPMP 206 and ensuring that the public key has not been corrupted, through typical integrity techniques such as Error Correction Code (ECC) Memory, Cyclic Redundancy Check (CRC), or one-way hash computed on the public key.

In another embodiment, the registration of the public key component of the AIK is through a fingerprint method. As is known to those skilled in the art, the fingerprint of a public key may be used to verify the validity of the public key. A fingerprint is essentially a cryptographic function computed over the public key. For example, the fingerprint may be a result of a one-way hash computation or residue from a symmetric cipher over the public key. In this embodiment, the fingerprint value derived from the public key component of the AIK may be registered with TPMP 206. Registration is done by a trusted administrator over a secure administrative path to TPMP 206. SBTPM 208 transfers the public key component of the AIK to TPMP 206 in the attestation reply, and the TPMP validates the public key component of the AIK against the previously registered fingerprint value prior to using the public key component of the AIK to ensure that the SBTPM generated the attestation reply.

In still another embodiment, the registration of the public key component of the AIK is through a certificate method. As is known to those skilled in the art, a digital certificate verifies that a sender's reported identity is the same as his actual identity. The digital certificate (or a one-way hash of the certificate components) is digitally signed by a certificate authority (CA) using asymmetric cryptography. A CA's public key is distributed to receivers of the certificate over a secure administrative path. The CA's public key can later be used by a receiver to validate that the certificate was signed by the CA. In this embodiment, the CA signs a public component of the AIK along with a unique identifying name. The CA's public key along with the unique identifying name may be registered with TPMP 206 through a secure administrative path when the TPMP is first installed and configured. SBTPM 208 then transfers the certificate to TPMP 206 with the integrity measurements in the attestation reply. TPMP 206 validates the certificate by using the CA's public key prior to using the SBTPM's public key component of the AIK in the certificate to decrypt the attestation reply.

In addition to validating the integrity measurements using the encryption methods described above, TPMP 206 also validates the measurement log by first reconstructing integrity measurements from the measurement log retrieved from memory 210. Thereafter, the integrity measurements in the attestation reply are compared against the reconstructed integrity measurements. Assuming that the validation passes, TPMP 206 then populates its platform configuration registers with integrity measurements from the measurement log and from the attestation reply that was returned by SBTPM 208. In populating the platform configuration registers, TPMP 206 may retain the association of integrity measurement to platform configuration registers that was used in SBTPM 208, or may allocate the integrity measurements to TPMP platform configuration registers differently than the allocation in the SBTPM under the control of the TPMP, platform designers, and system administrators.

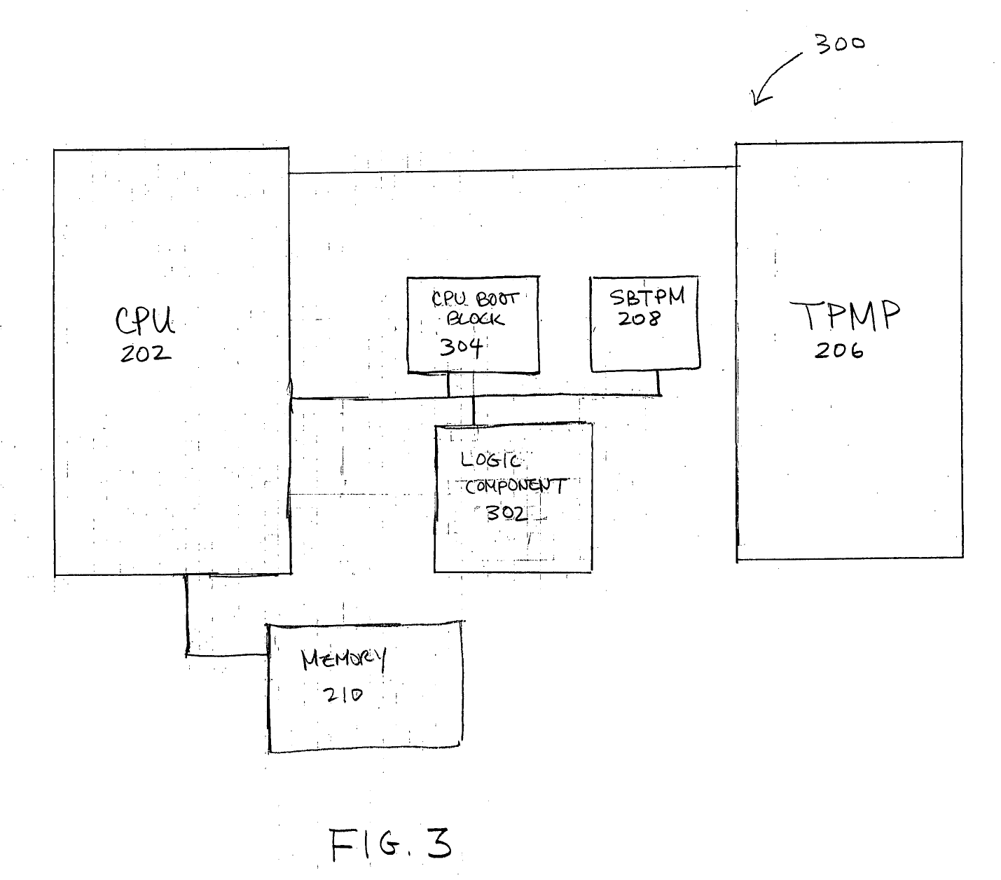

FIG. 3 is a simplified schematic diagram of a system for securing a computer boot, in accordance with one embodiment of the present invention. System 300 includes CPU 202, TPMP 206, SBTPM 208, memory 210, CPU boot block 304, and logic component 302. CPU boot block 304 may be stored in any suitable type of memory component, including read-only memory (ROM), programmable read-only memory (PROM), electrically erasable programmable read-only memory (EEPROM), random access memory (RAM), disk, etc. Logic component 302 may include any component with computational and input/output ability. Exemplary logic component 302 includes filed programmable gate arrays (FPGA), application specific integrated circuits (ASIC), service processors for managing and controlling the platform, special logic in the system CPU(s), etc.

In one embodiment, CPU 202 includes the logic for taking integrity measurement on CPU boot block 304 and logic for storing the integrity measurement in SBTPM 208. In another embodiment, logic component 302 may include the logic for taking integrity measurement on CPU boot block 304 and logic for storing the integrity measurement in SBTPM 208. If logic component 302 loads processing logic from memory, then that memory should be immutable (i.e., not changeable in the field). The execution of the logic in logic component 302 results in the computation of an integrity measurement on the code in CPU boot block 304 and the storage of the integrity measurement in a platform configuration register within SBTPM 208. Logic component 302 also maintains a measurement log in system memory accessible to the logic component 302. This becomes part of the system measurement log reported to the TPMP. This becomes part of the system measurement log reported to the TPMP. Subsequently, logic component 302 signals CPU 202 that the CPU may start booting from CPU boot block 304. The CPU then continues the recording of the integrity measurements in SBTPM 2-8 and the maintaining of the measurement log.

The functionality described above for securing a computer boot may be incorporated into any suitable chip or logic component. For example, in one embodiment, a chip (e.g., a SBTPM chip) may include circuitry for storing integrity measurements and circuitry for transferring the integrity measurements to a TPMP when the TPMP is initialized and accessible. In another embodiment, a logic component may include logic for executing instructions for taking integrity measurements of program code being loaded for execution during the computer boot and instructions for storing the integrity measurements in a SBTPM prior to the TPMP being initialized and accessible.

### II. Providing a Secure Communication Path Among System Components

After the TPMP is initialized and accessible, and the integrity measurements have been transferred to the TPMP, a secured communication path between the CPU running the TBCB and the TPMP is needed such that security critical information (e.g., domain identifiers, partition identifiers, zone identifiers, container identifiers, mandatory access control security labels, localities, etc.) can be transmitted between the CPU and the TPMP. The secured communication path authenticates to the TPMP that the source of information transmitted from the CPU is actually the TBCB program code and not another, unauthorized program code running on the CPU. Vice versa, the secured communication path may also authenticate the TPMP as the source of information transmitted to the TBCB. It should be appreciated that the communication path is not limited to between CPU and TPMP, but can be among any suitable system components, such as FPGA and TPMP. Two embodiments for providing a secure communication path between the TBCB and the TPMP are described below.

Basic Secured Path

To provide secure communication, the TBCB may transmit data using cryptographic methods to certify that the data is from a trusted source, such as a TBCB, rather than from an unauthorized program code.

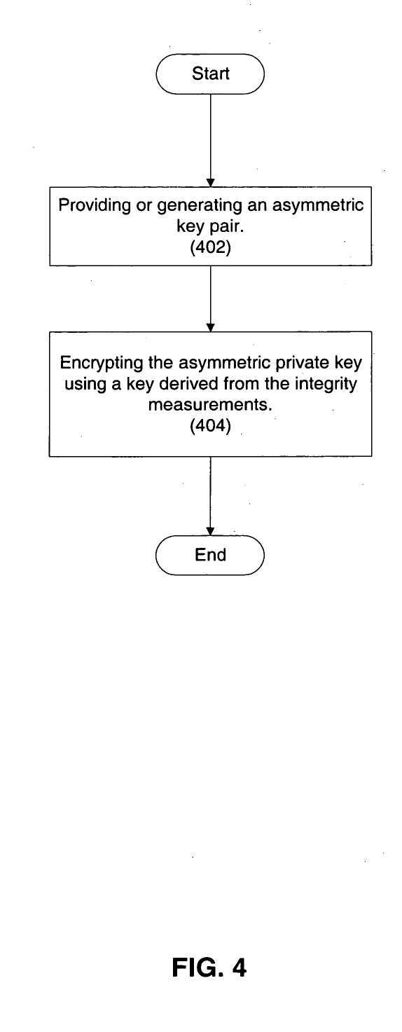

FIG. 4 is a flowchart diagram of a high level overview of a method for providing a basic secured path, in accordance with one embodiment of the present invention. Starting in operation 402, an asymmetric key pair is generated or provided. The asymmetric key pair is comprised of an asymmetric public key and an asymmetric private key. In one embodiment, the asymmetric key pair is provided to the TBCB through a secure administrative path. In another embodiment, the TBCB generates the asymmetric key pair. In still another embodiment, the TBCB commands the SBTPM to generate the asymmetric key pair.

The asymmetric private key is stored within the SBTPM and encrypted (i.e., sealed or wrapped) by the SBTPM using a key derived from the integrity measurements for the TBCB in operation 404. For example, in one embodiment, the key is defined by values in the platform configuration registers of the SBTPM containing the integrity measurements for the TBCB. Subsequently, as will be explained in more detail below, the asymmetric public key is registered with the TPMP. The asymmetric private key is encrypted by the SBTPM using a key derived from the integrity measurements for TBCB to ensure that the correct TBCB can access the asymmetric key pair. As a result, the encrypted asymmetric private key may be decrypted (i.e., unsealed or unwrapped) by the SBTPM if the same integrity measurements are taken after a subsequent computer boot. In other words, if the program code being loaded for execution has been modified after a subsequent computer boot, the integrity measurements would be different, and the integrity measurements associated with the modified program code cannot be used to decrypt the asymmetric private key. After the asymmetric private key has been decrypted, the asymmetric private key may be used to encrypt data (or a hash of the data) transmitted from the TBCB to the TPMP and to decrypt data transmitted from the TPMP to the TBCB.

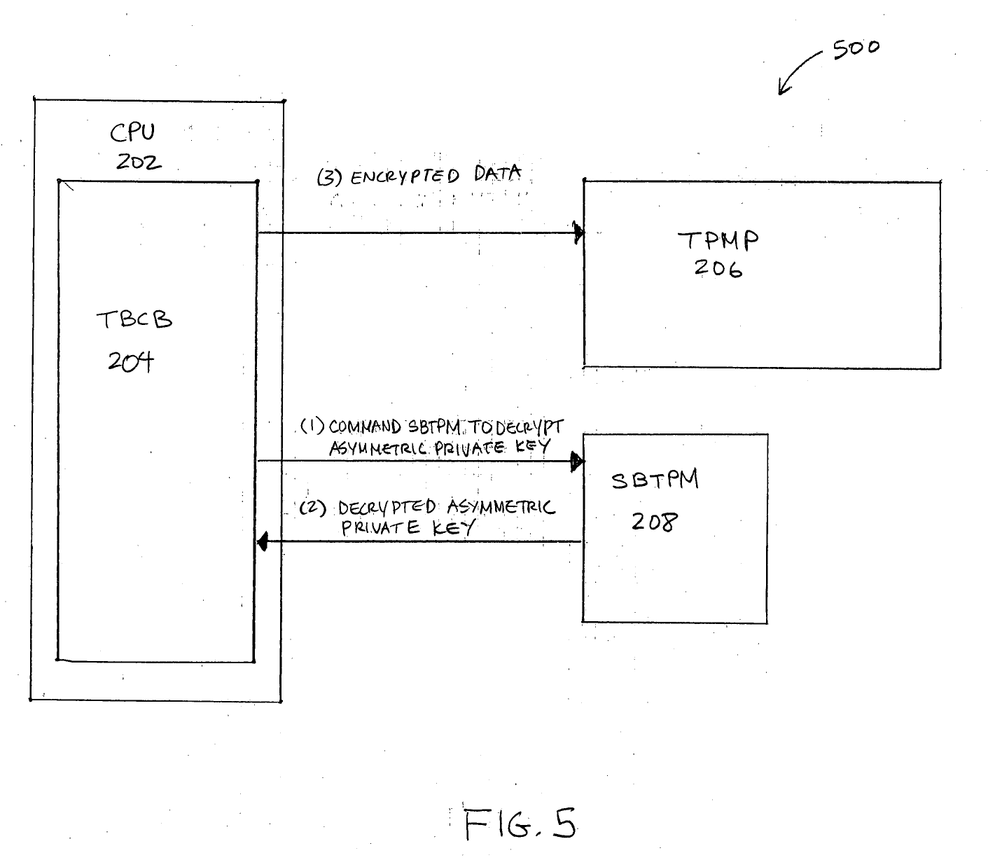

FIG. 5 is a simplified block diagram of a more detailed overview for providing a basic secured path, in accordance with one embodiment of the present invention. As shown in FIG. 5, computer system 500 includes CPU 202, TPMP 206, and SBTPM 208. As discussed above, in one embodiment, an asymmetric key pair is provided to TBCB 204 running on CPU 202 through a secure administrative path. In another embodiment, TBCB 204 generates the asymmetric key pair. In still another embodiment, the asymmetric key pair is generated in the SBTPM.

The asymmetric public key may be registered with TPMP 206 via one of several methods. In one embodiment, the asymmetric public key is registered using the public key method discussed above. With the public key method, the asymmetric public key can enter into TPMP 206 either through a secure administrative path to the TPMP, or by having TBCB 204 send the asymmetric public key to the TPMP when the TPMP is in a special configuration state. TPMP 206 may then use the asymmetric public key to decrypt data transmitted from TBCB 204 that has been encrypted using the associated asymmetric private key. When the public key method is used, the TPMP's validation of the asymmetric public key prior to using the asymmetric public key consists simply of retrieving the asymmetric public key from the memory of the TPMP and insuring that the asymmetric public key has not been corrupted, through typical memory integrity techniques such as Error Correction Code (ECC) Memory, a Cyclic Redundancy Check (CRC), or one-way hash computer on the asymmetric public key.

In another embodiment, the asymmetric public key is registered with TPMP 206 using the fingerprint method discussed above. With the fingerprint method, a fingerprint value derived from the asymmetric public key may be registered with TPMP 206 through a secure administrative path to the TPMP.

In still another embodiment, the asymmetric public key is registered with TPMP 206 using the certificate method discussed above. In this embodiment, a CA digitally signs the asymmetric public key along with a unique identifying name (or signs a hash of the asymmetric public key and the unique identifying name). The CA's public key associated with the signing key and the unique identifying name is entered into TPMP 206 via a secure administrative path to the TPMP.

After the asymmetric key pair is generated or provided, TBCB 204 commands SBTPM 208 to encrypt the associated asymmetric private key using a key derived from the integrity measurements for TBCB 204, in accordance with one embodiment of the present invention. After the asymmetric private key has been encrypted and stored in SBTPM 208, TBCB 204 may retrieve the asymmetric private key for later use when encrypting data transmitted to TPMP 206.

Subsequently, whenever TBCB 204 transmits data to TPMP 206, the TBCB first commands SBTPM 208 to decrypt the asymmetric private key using a key derived from the integrity measurements for TBCB 204. Decryption using the integrity measurements will fail if a different TBCB with different integrity measurements has been booted.

In one embodiment, TBCB 204 then commands SBTPM 208 to encrypt the data (or a hash of the data) to be transmitted to TPMP 206 using the decrypted asymmetric private key. In another embodiment, the TBCB 204 itself can encrypt the data (or a hash of the data) using the asymmetric private key retrieved from SBTPM 208. Using the pre-registered asymmetric public key, TPMP 206 can decrypt the data (or a hash of the data) using the asymmetric public key associated with the asymmetric private key, and thereby be assured that TBCB 204 sent the data. For example, using the public key method, the asymmetric public key has been pre-entered into the TPMP 206 and can be used to decrypt the data (or a hash of the data) sent by TBCB 204. Alternatively, using the fingerprint method, the asymmetric public key may be sent to TPMP 206, along with data being transmitted, and the TPMP can validate the asymmetric public key using the stored fingerprint values. TPMP 206 then uses the validated asymmetric public key to decrypt the transmitted data (or a hash of the data). With the certificate method, TBCB 204 sends a certificate containing the asymmetric public key and unique identifying name, signed by a CA, to TPMP 206 along with the data being transmitted. TPMP 206 uses the CA's public key, which was previously entered into the TPMP through a secure administrative path, to validate the asymmetric public key and unique identifying name, and matches the unique identifying name in the certificate with the expected name. The validated asymmetric public key may then be used to decrypt the transmitted data (or a hash of the data) from TBCB 204.

In another embodiment, a reverse secure communication path may also be set up to provide source authentication, integrity, and optional secrecy in the opposite direction for communications from TPMP 206 to TBCB 204. Essentially, to provide a reverse secure communication, the above-described method is reversed. Here, in one embodiment, TPMP 206 creates an asymmetric key pair, and the associated asymmetric public key is registered with TBCB 204 using either the public key method, fingerprint method, or the certificate method. The registration information for the asymmetric public key may optionally be stored in SBTPM 208 and encrypted using a key derived from the integrity measurements for TBCB 204. TPMP 206 then uses the asymmetric private key to encrypt data (or a hash of the data) transmitted to TBCB 204. Using the registration information, TBCB 204 may validate the asymmetric public key and use the validated asymmetric public key to decrypt data (or a hash of the data) transmitted by TPMP 206.

With the above-described basic secure communication path method for securing communication between TBCB 204 and TPMP 206, the TPMP can be assured that the data was transmitted by the TBCB, and not by unauthorized program code running in CPU 202. If the TBCB program code is modified, a trusted administrator, over a secure administrative path may command a new asymmetric key pair to be created in SBTPM 208 and encrypted using integrity measurements for the new TBCB. The trusted administrator registers the new asymmetric public key with the TPMP. Alternatively, the trusted administrator may command that the asymmetric private key be migrated to the new TBCB software configuration, causing the asymmetric private key to be encrypted in the integrity measurements of the new TBCB rather than the integrity measurements of the original TBCB.

High Performance Secured Path

To improve performance, a high performance secured path may be additionally provided to transfer security critical information between the TBCB and the TPMP. In contrast to the above described basic secured path that is based on asymmetric cryptography, the security mechanism for this high performance secured path is based on symmetric cryptography and a one-way hash algorithm. Communication based on symmetric cryptography is typically less computation intensive than communication based on asymmetric cryptography. As will be explained in more detail below, symmetric cryptography provides secrecy on the communication path between the TBCB and the TPMP, and the one-way hash algorithm provides integrity and source authentication.

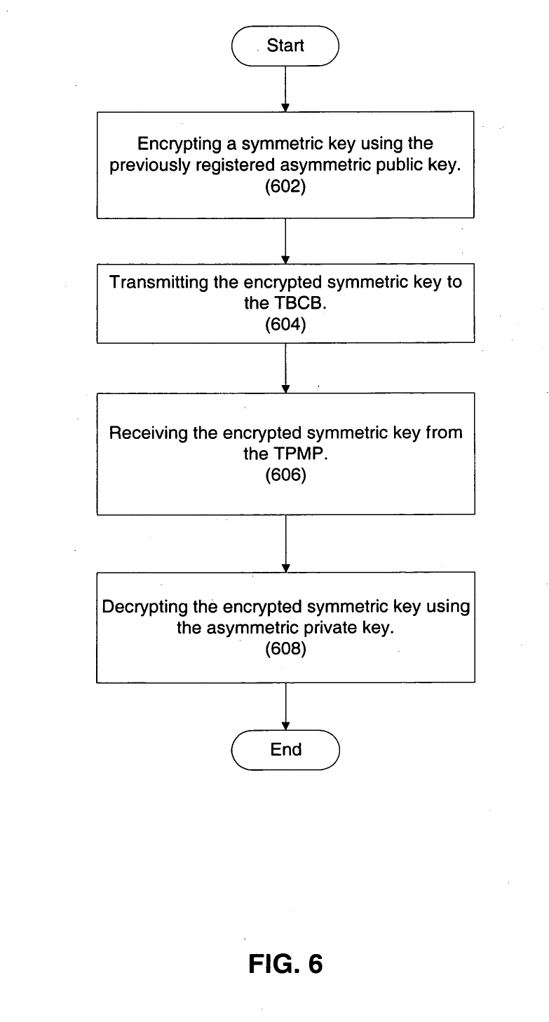

FIG. 6 is a flowchart diagram of a high level overview of a method for providing a high performance secured path, in accordance with one embodiment of the present invention. To provide a high performance secured path, a symmetric key needs to be shared between the TPMP and the TBCB. In one embodiment, the symmetric key may be distributed to the TBCB and the TPMP through secure administrative paths to each of the TBCB and TPMP. In another embodiment, the symmetric key may be distributed using the above described basic secured path. For example, the TBCB's asymmetric public key has been pre-registered with the TPMP using one of the methods described above. With the fingerprint or certificate method, the TBCB sends the asymmetric public key to the TPMP to start the key exchange. With the public key method, the TPMP already has the TBCB's asymmetric public key, such that a simple start message is all that is needed to start the key exchange.

Subsequently, the TPMP validates the asymmetric public key and then generates a symmetric key. As shown in FIG. 6, the TPMP then encrypts the symmetric key using the TBCB's asymmetric public key in operation 602. After encryption, the TPMP transmits the encrypted symmetric key to the TBCB in operation 604. The TBCB then receives the encrypted symmetric key in operation 606. As discussed above, the TBCB can command the SBTPM to decrypt the asymmetric private key that is encrypted in the SBTPM using a key derived from integrity measurements for TBCB. Accordingly, in operation 608, the TBCB uses the asymmetric private key to decrypt the symmetric key. As a result, the symmetric key is known to both TBCB and TPMP.

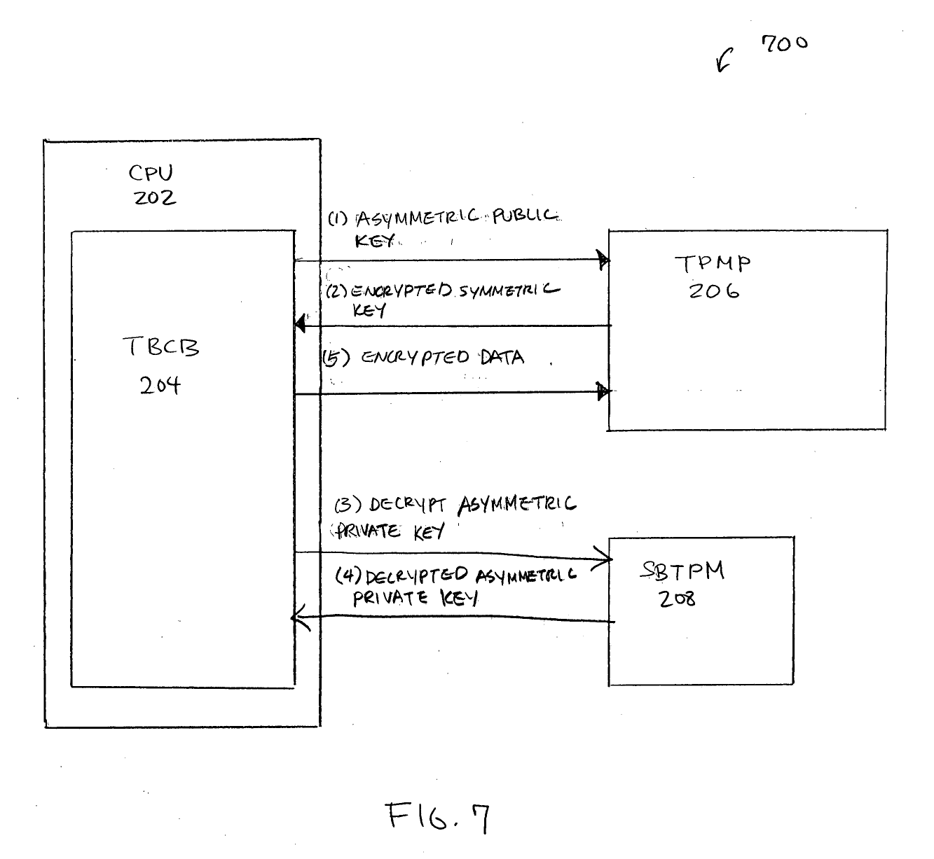

FIG. 7 is a simplified block diagram of a more detailed overview for providing a high performance secured path, in accordance with one embodiment of the present invention. As shown in FIG. 7, computer system 700 includes CPU 202, TPMP 206, and SBTPM 208. Computer system 700 boots up to the full TBCB 204 and the basic secured path as described above. A symmetric key is generated in TPMP 206, either using the TPMP's random number generator or from an external key generation source securely connected to the TPMP. TBCB 204 has previously registered its asymmetric public key with TPMP 206, and commanded the SBTPM to encrypt the asymmetric private key as described above for the basic secured path. With the fingerprint or certificate registration method, TBCB 204 sends the asymmetric public key to TPMP 206 to start the exchange. With the public key method, the asymmetric public key was entered into TPMP 206 via a secure administrative path, and a simple start message is used to start the key exchange.

TPMP 206 then uses the asymmetric public key to encrypt the symmetric key and transmits the encrypted symmetric key to TBCB 204. After receiving the encrypted symmetric key, TBCB 204 commands SBTPM 208 to decrypt the asymmetric private key, using a key derived from the integrity measurements for the TBCB. Thereafter, TBCB 204 decrypts the symmetric key using the decrypted asymmetric private key. In one embodiment, CPU 202 decrypts the symmetric key. In another embodiment, SBTPM 208 decrypts the symmetric key.

In some situations, bi-directional authentication is needed between TBCB 204 and TPMP 206. For example, in one embodiment, a reverse basic secured path as described above is first provided. As part of the symmetric key exchange, TPMP 206 signs, using its asymmetric private key, a nonce transmitted by TBCB 204 to TPMP 206 in the first part of the symmetric key exchange. The nonce is defined as a unique, numeric value for the key exchange. This signature also covers the encrypted symmetric key generated and sent by TPMP 206. TBCB 204 then validates the signature using the TPMP's asymmetric public key that is previously registered with the TBCB when the reverse basic secured path is provided, and decrypts the symmetric key using its asymmetric private key. If validation succeeds, then TBCB 204 knows that TPMP 206 sent the symmetric key.

In another embodiment, the key exchange with bi-directional authentication may also be reversed with TBCB 204 or SBTPM 208 generating the symmetric key and the TBCB sending the generated symmetric key to TPMP 206, encrypted using the TPMP's asymmetric public key. Bi-directional authentication may be performed by having TPMP 206 send a nonce to TBCB 204 in the first part of the key exchange, and the TBCB signs the nonce and the generated symmetric key using the asymmetric private key. TBCB 204 transmits the signed nonce and encrypted symmetric key to TPMP 206, and the TPMP validates the signature using the previously registered TBCB asymmetric public key and decrypts the symmetric key using the asymmetric private key.

In another exemplary embodiment, a Diffie-Hellman exchange between TPMP 206 and TBCB 204 may be used with optional bi-directional authentication. As is known to those skilled in the art, the Diffie-Hellman protocol allows two users to exchange a secret key over an insecure medium without prior secrets. Here, for bi-directional authentication, both TPMP 206 and TBCB 204 generate an asymmetric public and private key pair, and the TPMP and the TBCB both register their asymmetric public key with each other through a secure administrative path. Subsequently, each party generates a Diffie-Hellman public/private key pair and, for bi-directional authentication, signs the public key and a value known to the other party with their previously generated asymmetric private key and transmits the asymmetric private key to the other party. The receiving party validates the signature and uses the received Diffie-Hellman public key and its Diffie-Hellman private key to compute the symmetric key, according to the Diffie-Hellman algorithm.

The symmetric key may be stored in a memory accessible to CPU 202 or in SBTPM 208. When stored in SBTPM 208, the symmetric key may be encrypted by the SBTPM using a key derived from the integrity measurements for TBCB 204, in accordance with one embodiment of the present invention. In another embodiment, the symmetric key may also be stored in a secure key store within TPMP 206. When stored in SBTPM 208 and TPMP 206, the symmetric key may also be used across multiple platform boots. The retention of the symmetric key in this manner obviates the need to exchange keys for the high performance secured path for each computer boot. Additionally, the symmetric key that is encrypted using a key derived from integrity measurements needs to be migrated as discussed above whenever TBCB 204 is updated.

In sum, the high performance secured path relies on symmetric keys for source authentication, integrity, and secrecy of security critical information transferred between the TBCB and the TPMP. To protect communications, a symmetric cryptographic algorithm and a one-way hash algorithm may be used. The symmetric cryptographic algorithm provides secrecy while the one-way hash algorithm provides integrity and source authentication.

To provide secrecy, the symmetric key or a secret key derived from the symmetric key using an algorithm known to both the TBCB and the TPMP, is used for encrypting the data transmitted between the TBCB and the TPMP. The encryption may be done in addition to the one-way hash computation. Either the symmetric algorithm may be performed first and followed by the one-way hash using the encrypted data as input, or the one-way hash computation may be done first, followed by encrypting the data, nonce, and digest. The receiver uses the secret key to decrypt the data and validate the hash result. It should be appreciated that the secret key used for encryption may be different from the key used in the one-way hash computation.

To provide source authentication and integrity, a sender computes a one-way hash algorithm over the data being transmitted and over a symmetric key or a secret key derived from the symmetric key using a message authentication code known to both the TBCB and the TPMP. As discussed above, to prevent replays, the sender also includes a nonce as input to the one way hash algorithm. The nonce may be generated in the receiver (and transmitted to the sender), or generated in the sender (and transmitted to the receiver). The one-way hash computation result, known as a digest, is sent with the data, but the secret key is not sent. The receiver performs the same computation and compares the computation with the received digest. If the computation and the received digest matches, the sender is authenticated and the integrity of the received information is assured. The receiver also validates the uniqueness of the nonce or whether the nonce matches to what was supplied by the receiver if the receiver has supplied the nonce.

It will be apparent to one skilled in the art that the functionality described herein may be synthesized into firmware through a suitable hardware description language (HDL). For example, the HDL (e.g., VERILOG) may be employed to synthesize the firmware and the layout of the logic gates for providing the necessary functionality described herein to provide hardware implementations of providing a secure communication and of the computer boot securing techniques and associated functionalities. Thus, the embodiments described herein may be captured in any suitable form or format that accomplishes the functionality described herein and is not limited to a particular form or format.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A method for securing a computer boot, comprising method operations of:
taking integrity measurements of program code being loaded for execution during the computer boot;
storing the integrity measurements in a system board trusted platform module (SBTPM); and
transferring the integrity measurements from the SBTPM to a trusted platform module peripheral (TPMP) when the TPMP is initialized and accessible.

2. The method of claim 1, further comprising:
maintaining a measurement log that includes descriptions of the integrity measurements; and
transferring the measurement log to the TPMP when the TPMP is initialized and accessible.

3. The method of claim 1, wherein the method operation of transferring the integrity measurements from the SBTPM to the TPMP when the TPMP is initialized and accessible includes,
communicating an attestation challenge from the TPMP to the SBTPM; and
communicating an attestation reply from the SBTPM to the TPMP in response to the attestation challenge, the attestation reply including the integrity measurements being encrypted using a private key component of an attestation identification key pair (AIK).

4. The method of claim 3, wherein a public key component of the AIK is registered with the TPMP using one of a public key method, a fingerprint method, and a certificate method.

5. The method of claim 3, further comprising:
decrypting the attestation reply by using a public key component of the AIK associated with the private key component of the AIK, the decryption being done by the TPMP.

6. The method of claim 4, wherein the public key component of the AIK is registered with the TPMP through a secure administrative path for the public key method.

7. The method of claim 4, wherein a value derived from the public key component of the AIK is registered with the TPMP through a secure administrative path for the fingerprint method.

8. The method of claim 4, wherein the public key component of the AIK and an unique identifying name are signed by a certificate authority, and a public key of the certificate authority and the unique identifying name are stored in the TPMP through a secure administrative path for the certificate method.

9. The method of claim 3, further comprising:
reconstructing the integrity measurements in the attestation reply from information in a measurement log, the reconstruction being done by the TPMP.

10. The method of claim 1, wherein the integrity measurements are cryptographic checksums of the program code being loaded during the computer boot.

11. A system for securing a computer boot, comprising:
a central processing unit (CPU) including,
logic for executing instructions for taking integrity measurements of program code being loaded for execution during the computer boot, and
logic for executing instructions for storing the integrity measurements in a system board trusted platform module (SBTPM) until a trusted platform module peripheral (TPMP) is initialized and accessible;
the SBTPM in communication with the CPU configured to store the integrity measurements, the SBTPM including logic for executing instructions for transferring the integrity measurements to the TPMP after the TPMP is initialized and accessible; and
the TPMP in communication with the CPU configured to receive and store the integrity measurements.

12. The system of claim 11, further comprising:
a memory in communication with the CPU configured to store a measurement log.

13. The system of claim 12, wherein the CPU includes,
logic for executing instructions for maintaining a measurement log in the memory; and
logic for executing instructions for transferring the measurement log from the memory to the TPMP when the TPMP is initialized and accessible.

14. The system of claim 11, wherein the TPMP is configured to receive and process the measurement log.

15. The system of claim 11, further comprising:
a CPU boot block in communication with the CPU.

16. The system of claim 11, wherein the TPMP is defined by a trusted platform module within one or more of a peripheral component interconnect (PCI) card, a PCI-X card, a PCI-Express card, an infiniband terminal communications adapter, and a network appliance.

17. The system of claim 11, wherein the SBTPM is a secure micro-controller with cryptographic functionalities that is physically attached to a platform accessible by the CPU.

18. The system of claim 11, wherein the memory is defined by one of a static random access memory and a dynamic random access memory.

19. A system for securing a computer boot, comprising:
a logic component including,
logic for executing instructions for taking integrity measurements of program code being loaded for execution during the computer boot, and
logic for executing instructions for storing the integrity measurements in a system board trusted platform module (SBTPM) until a trusted platform module peripheral (TPMP) is initialized and accessible;
the SBTPM in communication with the logic component configured to store the integrity measurements; and
the TPMP in communication with the SBTPM, the TPMP including logic for receiving the integrity measurements from the SBTPM after the TPMP is initialized and accessible.

20. The system of claim 19, wherein the logic component is defined by one of a field programmable gate array, an application specific integrated circuit, a service processor provided with the system for system control and management, and special logic in a central processing unit (CPU) of the system.

21. A chip for securing a computer boot, comprising:
circuitry for storing integrity measurements; and
circuitry for transferring the integrity measurements to a trusted platform module peripheral (TPMP) when the TPMP is initialized and accessible.

22. The chip of claim 20, wherein the chip is a system board trusted platform module (SBTPM).

23. A trusted platform module peripheral (TPMP) for securing a computer boot, comprising:
logic for receiving registration information for an attestation identification key pair (AIK) over a secure administrative path;
logic for receiving an AIK public key;
logic for validating the AIK public key;
logic for communicating an attestation challenge to a system board trusted platform module (SBTPM) when the TPMP is initialized and accessible; and
logic for receiving an attestation reply from the SBTPM.

24. The TPMP of claim 23, further comprising:
logic for decrypting the attestation reply using the AIK public key;
logic for receiving a measurement log;
logic for reconstructing integrity measurements from the measurement log; and
logic for comparing the received integrity measurements in the decrypted attestation reply with the reconstructed integrity measurements.

25. The TPMP of claim 24, further comprising:
logic for storing the integrity measurements received from the measurement log;
logic for receiving additional integrity measurements; and
logic for storing the additional integrity measurements.
